(19) United States
(12) Patent Application Publication
(10) Pub. No.: US 2013/0294945 A1
(43) Pub. Date: Nov. 7, 2013

(54) Water Pump and Methods of Use Thereof

(71) Applicant: Robert Bennett, Gilmer, TX (US)

(72) Inventor: Robert Bennett, Gilmer, TX (US)

(21) Appl. No.: 13/996,538

(22) PCT Filed: Dec. 20, 2011
(86) PCT No.: PCT/US11/66319

§ 371 Date: Jun. 20, 2013

Related U.S. Application Data
(60) Provisional application No. 61/424,911, filed on Dec. 20, 2010.

(51) Int. Cl. F03B 13/00

(52) U.S. Cl. CPC F03B 13/00
USPC 417/61

(57) ABSTRACT

A system for pumping water in a body of water from a first depth to a second depth using energy generated by a passing wave. The system can have a floatable member and a submergible member having a conduit and a valve, a vertical support, a stabilization member, a passageway, and a depth adjusting member.

### CROSS-REFERENCE TO RELATED APPLICATION

This patent application claims the benefit of the priority of U.S. Provisional Application No. 61/424,911, filed on Dec. 20, 2010, and the PCT Patent Application PCT/US2011/066319, filed on Dec. 20, 2011. Each of the U.S. Provisional Application No. 61/424,911 and PCT Application No. PCT/US2011/066319 are incorporated herein by reference in its entirety.

### BACKGROUND

The present description herein generally relates to altering water temperatures, dissolved matter, and particulate matter in bodies of water such as oceans, lakes, rivers, and structures capable of being utilized in the alteration. The description also generally relates to the field of structures for altering the weather conditions for the creation of and/or the maintenance of a hurricane or similar weather.

The primary energy source of a hurricane is the release of heat from water vapor condensation, with solar heating being the initial source for evaporation. A hurricane can be visualized as a giant vertical heat engine supported by mechanics driven by physical forces such as the rotation and gravity of the Earth. The inflow of warmth and moisture from the underlying ocean surface is critical for hurricane strengthening. Water condensation leads to higher wind speeds, as a tiny fraction of the released energy is converted into mechanical energy; the faster winds and lower pressure associated with them in turn cause increased surface evaporation and thus more condensation. Much of the released energy drives updrafts that increase the height of the storm clouds, speeding up condensation. This positive feedback loop continues for as long as conditions are favorable for hurricane development. To continue to drive its heat engine, a hurricane must remain over warm water, which provides the needed atmospheric moisture to keep the positive feedback loop running. When a hurricane passes over land, it is cut off from its heat source and its strength diminishes rapidly.

Most of the heat energy of sunlight is absorbed in the surface layer of the ocean. Waves mix the water near the surface layer and distribute heat to deeper water, such that the temperature may be relatively uniform for up to 100 m (300 ft), depending on wave strength and the existence of surface turbulence caused by currents. Below this mixed layer, however, the water temperature drops rapidly with depth. This area of rapid transition is called the thermocline. Below the thermocline, the water temperature continues to decrease with depth, but far more gradually. Therefore, cooler water at lower depth can be brought to the higher depth to cool the temperature of the surface layer.

An increase in the level of surface layer phytoplankton concentration can increase the carbon sequestration efficiency of the ocean, increase ocean based fauna or flora populations, and increase fish concentration. Insufficient surface layer nutrients limit the surface layer phytoplankton concentration. While these nutrients are limited in the surface layer, they are abundant in the subsurface layer. Water brought from a lower ocean depth to a higher ocean depth would increase the phytoplankton concentrations, thereby increasing the carbon sequestration efficiency of the ocean, increase ocean based fauna or flora population, and increase fish concentration.

### SUMMARY OF THE INVENTION

The present disclosure provides for a system for pumping water. One aspect of the disclosure is a system for pumping water having a floatable member and a submergible member capable of allowing water to flow in one direction, where the submergible member has a conduit and a valve coupled to the conduit. In one aspect of the disclosure, the conduit extends downward from the floatable member and has a length extending to a first depth at which a property of water at the first depth substantially differs from the property of water at a second depth. In one aspect of the disclosure, the property of water is water temperature, dissolved-gas concentration, water chemical composition, or water biological composition. In one aspect of the disclosure, the system is used for biological management. In one aspect of the disclosure, the system is used for weather management. In one aspect of the disclosure, the system is used for water temperature control.

In one aspect of the disclosure, the valve has a valve member, a valve housing, and a hinge. In one aspect of the disclosure, the valve member is a flap valve. In one aspect of the disclosure, the valve can have a valve stop. In one aspect of the disclosure, system has a connection member capable of coupling the submergible member to the floatable member. In one aspect of the disclosure, system has a connection device capable of coupling a connector support to the connection member. In one aspect of the disclosure, the system has a vertical support configured to receive a vertical force. In one aspect of the disclosure, the vertical support structure engages a first valve and a second valve. In one aspect of the disclosure, the system has a stabilization member capable of decreasing horizontal movement.

In one aspect of the disclosure, the submergible member has a passageway capable of allowing water to pass from the interior of the conduit to the exterior of the conduit. In one aspect of the disclosure, the system has a plurality of conduits. In one aspect of the disclosure, the system has a plurality of valves. In one aspect of the disclosure, the system has a depth adjusting member capable of adjusting the depth of the submergible member.

### BRIEF DESCRIPTION OF THE DRAWINGS

The accompanying drawings, which are incorporated herein and form part of the specification, illustrate various embodiments of the present disclosure and together with the description, further serve to explain the principles of the disclosure and to enable a person skilled in the pertinent art to make and use the disclosure. In the drawings, like reference numbers indicate identical or functionally similar elements. A more complete appreciation of the disclosure and many of the attendant advantages thereof will be readily obtained as the same becomes better understood by reference to the following detailed description when considered in connection with the accompanying drawings, wherein:

FIG. 1 is a side elevation view of the water pump according to an exemplary embodiment of the present disclosure.

FIG. 2 is a perspective view of the valve according to an exemplary embodiment of the present disclosure.

FIG. 3a is a side elevation view of the submergible portion according to an exemplary embodiment of the present disclosure.

FIG. 3b is a perspective view of the submergible portion according to an exemplary embodiment of the present disclosure.

FIG. 4 is a side elevation view of the water pump according to an exemplary embodiment of the present disclosure.

FIG. 5 is a top down view of the water pump conglomerate according to an exemplary embodiment of the present disclosure.

FIG. 6 is a side elevation view of the submergible portion according to an exemplary embodiment of the present disclosure.

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

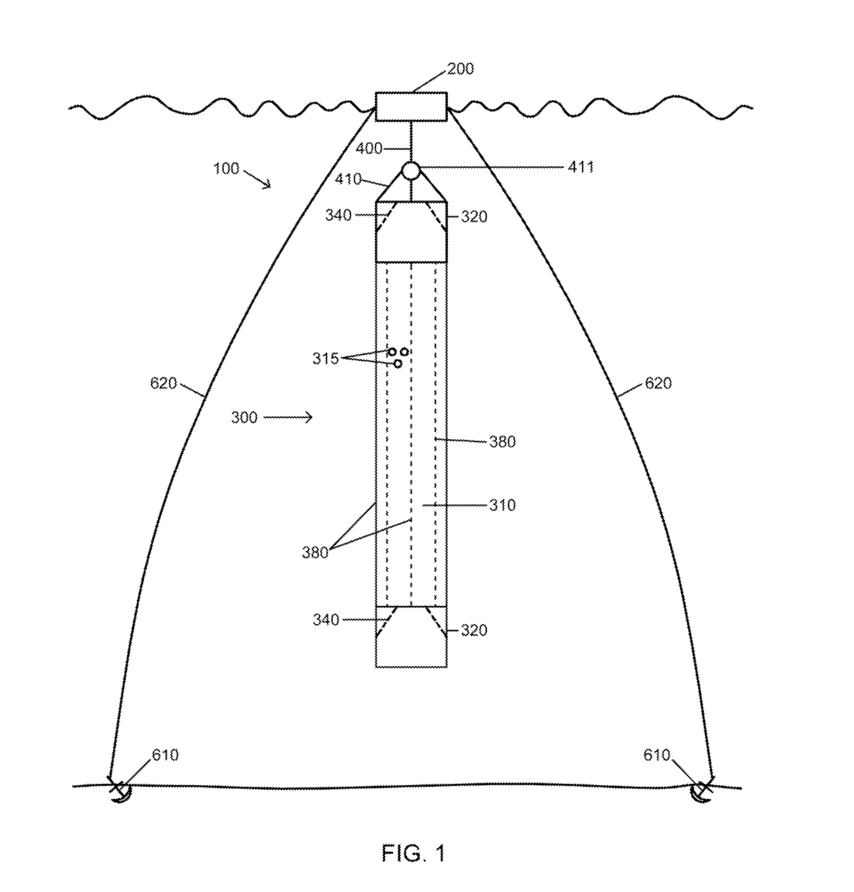

The present disclosure pertains to a water pump 100 for displacing water in a body of water using energy generated by a passing wave. As shown in FIG. 1, the water pump 100 has a floatable member 200 and a submergible member 300. The floatable member 200 is any object capable of floating. The floatable member 200 is capable of preventing the submergible member 300 from sinking. The floatable member 200 is capable of pulling the submergible member 300 in a vertical direction to a shallower depth. The floatable member 200 is preferably a buoy. Upon the passing of a wave, the buoyancy of the floatable member 200 causes the floatable member 200 to remain on the surface of the water causing the passing wave to raise the floatable member 200 to a new height in relation to the floor of the body of water. The amount of buoyancy of the floatable member 200 required to prevent the submergible member 300 from sinking or to pull the submergible member 300 to a shallower depth can depend on a number of factors associated with the submergible member 300, for example, without limitation, size, weight, composition, desired amount of water to be pumped, or the like. It is also contemplated that the floatable member 200 can have any desired composition, from rigid material like metal or wood, to flexible material including plastic, foam, and composites. The floatable member 200 is preferably coated with a sealer, including plastic, or the like, for added resistance to environmental elements.

The submergible member 300 is capable of allowing water to flow in one direction, for example, without limitation, from a first depth to a shallower depth or from a first depth to a deeper depth. In the preferred embodiment, the submergible member 300 has a conduit 310 and a valve 320.

The conduit 310 can be anything capable of carrying water from a first depth to a second depth. In the preferred embodiment, the conduit 310 extends downward from a surface layer depth to a deeper depth and is positioned substantially normal to the floor of the body of water. All deeper depths are contemplated for example, without limitation, those found in the pelagic zones. The conduit has an exterior surface 311, an interior surface 312, a first end 313, and a second end 314. The conduit 310 has a length extending from a first depth to a second depth where a property of water at the first depth differs from that property of water at the second depth. For example, the conduit 310 can extend from a first depth of one temperature to a second depth of another temperature, for example, extending through the ocean thermocline. A wide range of pycnoclines are contemplated, for example, without limitation, a thermocline, a halocline, a chemocline, or the like. A wide range of water properties are contemplated, for example, without limitation, water temperature, dissolved-gas concentration, water chemical composition, or water biological composition. The conduit 310 can have any diameter depending on the preferred amount of displaced water. While the conduit 310 can be a flexible or rigid structure, the conduit 310 is preferably rigid. The rigidness of the conduit 310 prevents the conduit 310 from collapsing due to ocean currents, pressure, or other oceanic influences, thereby allowing for proper water flow.

In one embodiment, the conduit 310 can have at least one passageway 315 capable of allowing water to pass through the conduit 310. The passageway 315 is preferably a one-way passageway where water is allowed to flow through the passageway 315 in one direction and is prevented from flowing through the passageway 315 in another direction. For example, the passageway 315 allows water to pass from the interior of the conduit 310 to the exterior of the conduit 310. The passageway 315 may be designed to allow water to pass based on specific conditions, for example, without limitation, changes in pressure, changes in temperature, or the like. The passageway 315 may vary in size and shape. The distribution of the passageway 315 may be uniform over the outer surface of the conduit 310 or may vary depending on design considerations. While the passageway 315 is preferably a passive passageway, all types of passageways 315 are contemplated, for example, without limitation, using flaps, check valves, rotating drums, gate valves, or similar mechanisms to support unidirectional flow, or active passageways utilizing motorized or variable flow control devices such as valves, flaps, rotating drums, or the like.

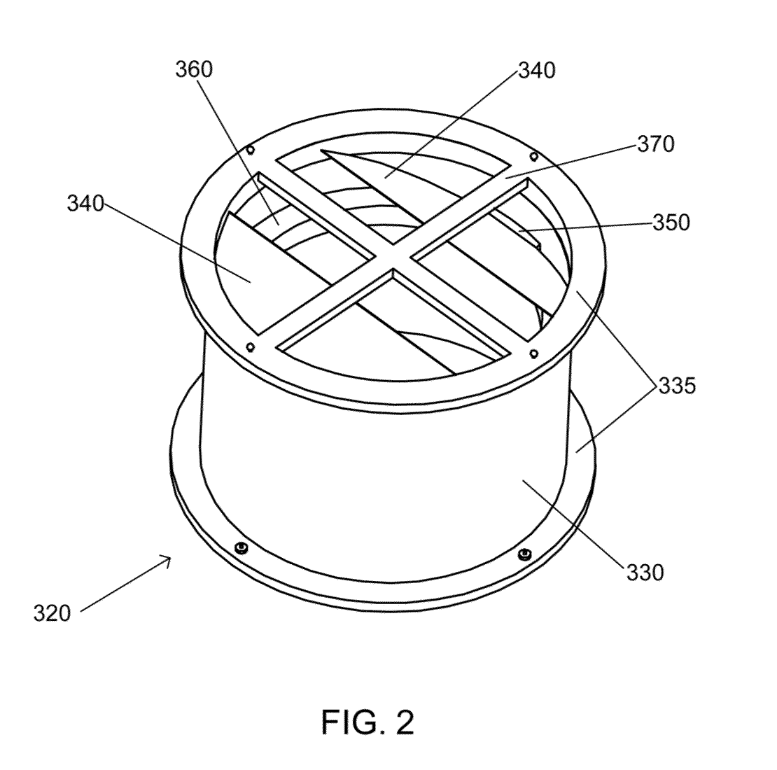

The valve 320 is capable of preventing back flow of water through the submergible member 300, thereby moving water through the conduit 310. As shown in FIG. 2, the valve 320 can have a valve housing 330, a valve member 340, and a hinge 350. The valve 320 can engage the first end 313 or the second end 314 of the conduit 310. The water pump 100 can have a plurality of valves 320, the number of which corresponds to the depth of the displaced water. The valve housing 330 provides support for the valve member 340 and allows water to flow through the valve housing 330 from a first conduit 310 to a second conduit 310. The valve housing 330 has an exterior surface 331, an interior surface 332, a first end 333, and a second end 334.

The valve member 340 allows for water to flow in one direction and prevents water from flowing in another direction. The valve member 340 engages the interior surface 332 of the valve housing 330 by way of a hinge 350. The hinge 350 can be any means of connecting a valve member 340 to a valve housing 330, for example, without limitation, a hinge, a living hinge, a swivel hinge, or the like. The hinge 350 rotationally engages the valve housing 330 thereby allowing for the rotation of the valve member 340 around the horizontal axis of the hinge 350. The hinge 350 can be made of any rigid or flexible material, for example, without limitation, plastic, wood, metal, or the like. In the preferred aspect, the hinge 350 is made of metal. While the valve member 340 is preferably a flap valve, all types of valves are contemplated, for example, without limitation, passive valves utilizing flaps, check valves, rotating drums, gate valves, or similar mechanisms to support unidirectional flow, or active valves utilizing motorized or variable flow control devices such as valves, flaps, rotating drums, or the like. In addition, the valve 320 can have a plurality of valve members 340. In the preferred embodiment, the valve 320 has two valve members 340 in the form of a flap valve. In one embodiment, the valve member 340 can be removed from the valve 320 rendering the valve 320 as a collar allowing for the reinforcement of the submergible member 300.

In the preferred embodiment, the valve 320 engages the conduit 310 by way of the valve housing 330. The valve housing 330 can engage with the first end 313 or the second end 314 of the conduit 310. The valve housing 330 can be coupled to the conduit 310 by any mechanism that allows for the coupling of two conduits 310 together. In one embodiment, the exterior diameter of the valve housing 330 measured from the exterior surface on one side of the valve housing 350 to the exterior surface on the opposite side of the valve housing 330 is slightly less than the interior diameter of the conduit 310 measured from the interior surface 312 of one side of the conduit 310 to the interior surface 312 on the opposite side of the conduit 310. By way of example, the first end 313 of the conduit 310 can slide around the first end 333 of the valve housing 330 and a cinching member 337 can be used to tighten the conduit 310 to the valve housing 330. The cinching member 337 can be any means that cinches the conduit 310 to the valve housing 330, for example, without limitation, an o-ring, an o-clamp, a cable tie, or the like.

Alternatively, the exterior diameter of the conduit 310 measured from the exterior surface 311 of one side of the conduit 310 to the exterior surface 311 of the opposite side of the conduit 310 is slightly less than the interior diameter of the valve housing 330 measured from the interior surface 332 of one side of the valve housing 330 to the interior surface 332 of the opposite side of the valve housing 320. By way of example, the first end 333 of the valve housing 330 can slide around the first end 313 of the conduit 310 and the cinching member 337 can be used to tighten the valve housing 330 to the conduit 310.

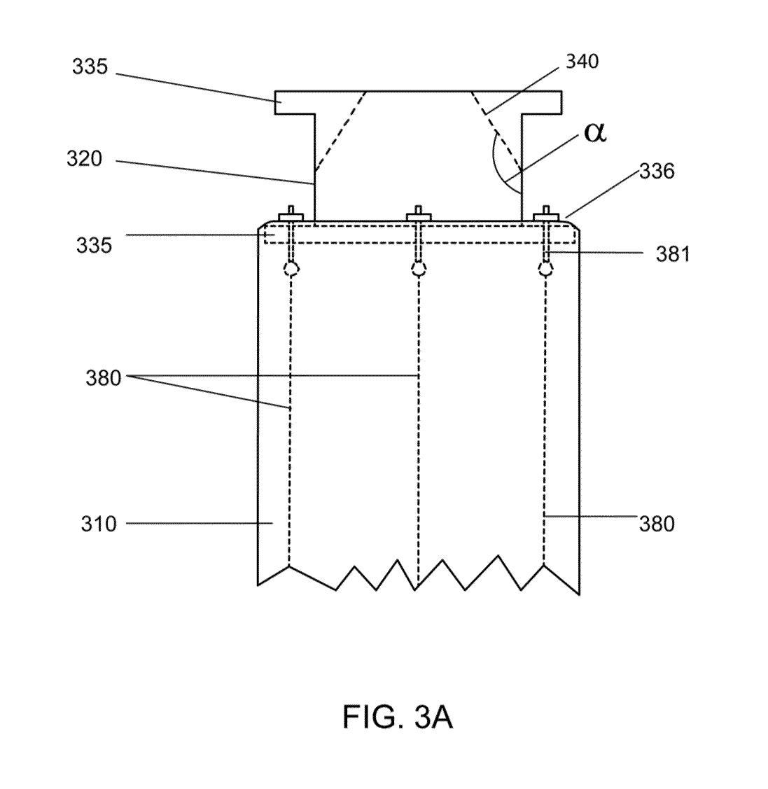

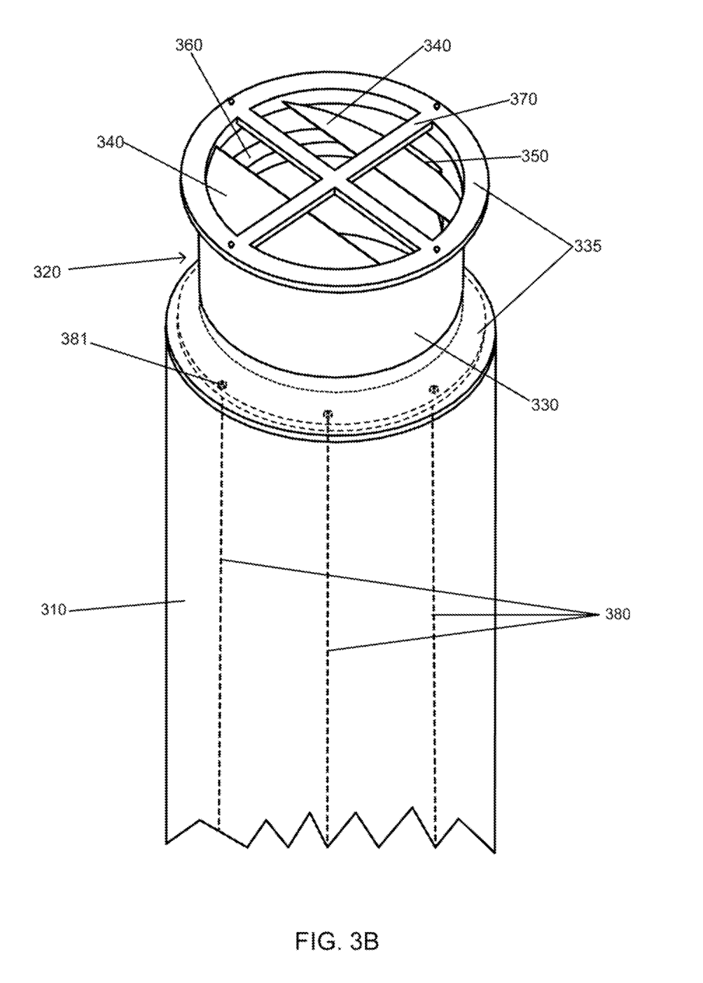

In the preferred embodiment, as shown in FIG. 3a and 3b, the valve housing 330 has a valve lip 335 that prevents the cinching member 337, and thus the conduit 310, from sliding off the valve housing 330. The valve lip 335 runs the circumferential periphery of the exterior surface 331 of the valve housing 330 and is positioned on the first end 333 and/or the second end 334 of the valve housing 330. The valve lip 335 is preferably any width measuring between the exterior surface 336 of the valve lip and the exterior surface 311 of the conduit 310 that prevents the cinching member from sliding off the value housing 330. However, all suitable valve lip 335 widths are contemplated. In this embodiment, the conduit 310 slides over the exterior surface 336 of the valve lip 335 and a portion of the valve housing 330. The conduit 310 is cinched to the valve housing 330 using the cinching member 337 as described above. In the preferred embodiment, the valve housing 330 has two valve lips 335, one located on the first end 333 and one located on the second end 334 of the valve housing 330.

In one embodiment, the valve 320 can have a valve stop 360 capable of preventing the valve member 340 from rotating beyond a valve angle α. As shown in FIG. 2, the valve stop 360 engages the interior surface 332 of the valve housing 330 and is positioned in a manner that prevents the valve member 340 from rotating beyond a horizontal plane. While all forms of the valve stop 360 are contemplated, for example, without limitation, a peg, a block, a chain stop, or the like, the valve stop 360 is preferably a ledge that resembles the shape of the valve member 340. For example, without limitation, where the valve 320 has two valve members 340 in the form of two semicircle flaps that form a circle when in the horizontal position, the valve stop 360 is a ledge that circumferentially runs along the interior surface 323 of the conduit 310. The width of the ledge measured from the interior surface 323 of the conduit 310 to the lip of the ledge is any width that allows the valve member 340 to rest upon the valve stop 360, thereby preventing the valve member 340 from rotating beyond a horizontal plane.

In one embodiment, the valve 320 can have a brace 370 to provide horizontal strength to the valve 320. In one embodiment, the brace 370 prevents the valve 320 from collapsing. In one embodiment, the brace 370 prevents the conduit 315 from stretching or tearing. While all forms of braces 370 are contemplated, the brace 370 is preferably a cross brace 370 where two brace members 371 are connected in the center of each brace member 371 substantially normal to each other and the two ends of each brace member 371 engage the interior surface 332 of the valve housing 330. While the brace 370 preferably engages the valve housing 330 at the first end 333 or second end 334 of the valve housing 330 to allow for the rotation of the valve members 340 around the hinge 350, the brace 370 can engage the conduit 315. The valve 320 can have a plurality of braces 370, including two braces 370 where one brace 370 engages the first end 333 of the valve housing 330 and the other brace 370 engages the second end 334 of the valve housing 330.

The valve 320 operates in the following manner when used to displace water from a first depth to a shallower depth. As the conduit 310 descends, the water from beneath the valve member 340 exerts a force on the valve member 340. This force pushes the valve member 340 open, thereby causing the valve member 340 to rotate around the hinge 350. The valve member 340 continues to rotate around the hinge 350 until ending in a substantially vertical position, thereby allowing water to flow through the valve member 340. As the conduit 310 begins to ascend, the force from the water contained in the conduit 310 above the valve member 340 pushes the valve member 340 down thereby causing the valve member 340 to rotate around the hinge 350 until it rests against the valve stop 360. The valve member 340 is now in a substantially horizontal position, thereby preventing water from flowing back through the valve 320 and pushing the water through the conduit 310.

The submergible member 300, valve 320, valve housing 330, valve member 340, valve stop 360, conduit 310, and brace 370 can be made of any rigid material, for example without limitation, composite, plastic, wood, metal, or the like. In the preferred embodiment, the water pump 100 and components therein are made of composite.

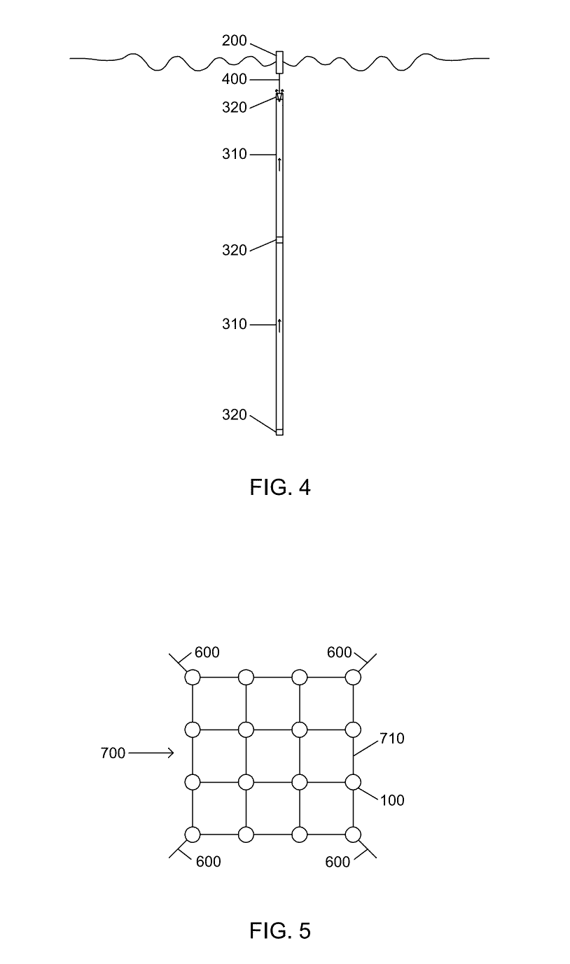

In one embodiment, as shown in FIG. 4, the water pump 100 can have a plurality of submergible members 300 for greater water displacement capability. In another embodiment, the submergible member 300 can have additional conduits 310 and valves 320 connected in a substantially linear manner that allow the water pump 100 to reach deeper water depths and thus colder water. The number of conduits 310 and valves 320 can depend on the preferred depth of the displace water by the water pump 100.

In one embodiment, as shown in FIG. 3a and 3b, the submergible member 300 has a vertical support 380 configured to receive the vertical force, or a force substantially normal to the surface of a body of water, created by the floatable member 200 when a passing wave raises the floatable member 200, thereby pulling the submergible member 300 in a vertical direction. In one embodiment, one end of the vertical support 380 engages the first valve 320 and the other end of the vertical support 380 engages the second valve 320. By receiving the vertical force, the vertical support 380 prevents vertical strain to be received by the conduit 310 and/or the point of engagement between the conduit 310 and the valve 320. The vertical supports avoid damage to the submergible member, for example, the conduit 310. The length of the vertical support 380 can be slightly shorter than the length of the conduit 310, thereby allowing the vertical support 380 to receive the vertical force created when the floatable member 200 pulls the submergible member 300 in a vertical direction by the passing of a wave. The vertical support 380 is preferably a steel cable. However, all suitable vertical supports 380 are contemplated. The vertical supports 380 can have a width suitable to receive the vertical force created by the passing of a wave. In one embodiment, as shown in FIG. 1, one end of the vertical support 380 engages the bottom of a first valve 320 while the second end of the vertical support 380 engages the top of a second valve 320. The vertical support 380 extends substantially parallel to the vertical axis of the conduit 310 and can be positioned in close proximity to the exterior surface of the conduit 310. While the vertical support 380 is preferably coupled to the valve lip 335 of the valve 320, all types of engagement are contemplated. For example, the vertical support 380 can engage the side of the valve housing 330. Eye bolts 381 can be used to couple the vertical support 380 with the valve 320 where, by way of example, the eye bolt 381 engages the valve lip 335 or the valve housing 330, and the steel cable engages the eye bolts 381.

The submergible member 300 can have a plurality of vertical supports 380 determined by the rigidity of the conduit 310. A more rigid conduit 310 would require less vertical supports 380 while a more flexible conduit 310 would require more vertical supports 380. The vertical supports 380 can also be positioned in the interior of the conduit 310, for example, without limitation, a vertical support 380 can run through the vertical axis of the conduit 310 or in close proximity to the interior surface of the conduit 310.

In the preferred embodiment, the water pump 100 can have a connection member 400 capable of coupling the floatable member 200 with the submergible member 300. One end of the connection member 400 engages the floatable member 200 while the other end of the connection member 400 engages the submergible member 300. The water pump 100 can have a connector support 410 used to provide additional support for the connection member 400. In one embodiment, the water pump 100 can have a connection device 411 that couples a connector support 410 to the connection member 400. In this embodiment, one end of the connector support 410 is coupled to the connection device 411 and another end of the connection support 410 is coupled to the submergible member 300. While all forms of the connection member 400, connector support 410, and means of connecting the connection member 400 and connector support 410 to the water pump 100, are contemplated, said components are preferably a steel cable similar to that described as the vertical support 380. Said components engage the water pump 100 similar to the engagement of the vertical support 380 with the water pump 100. The water pump 100 can have a plurality of connection members 400.

In one embodiment, the water pump 100 can have a depth altering member that allows the bottom of the submergible member 300 to be raised or lowered depending on the preferred depth of the displaced water. While all suitable means of incorporating the depth altering member into the water pump 100 are contemplated, the depth altering member is preferably incorporated into the connection member 400. Here, the depth altering member can be any means capable of extending the length of the connection member 400 between the floatable member 200 and the submergible member 300. The depth altering member is preferably a steel cable.

The water pump 100 can also have a stabilization member 600 that decreases horizontal movement of the water pump 100. The stabilization member 600 can have an anchor 610 and an anchor line 620 where one end of the anchor line 620 engages the water pump 100 and another end of the anchor line 620 engages the anchor 610. The anchor 610 engages with the floor of the body of water in a manner that decreases horizontal movement while simultaneously allowing for the water pump 100 to ascend and descend due to a passing wave. In the preferred embodiment, as shown in FIG. 1, the water pump 100 has two stabilization members 600 where one stabilization member 600 engages one side of the water pump 100 and the other stabilization member 600 engages the opposite side of the water pump 100. In this embodiment, the stabilization members 600 extend out from the water pump 100 in opposite directions, thereby decreasing movement of the water pump 100 in any horizontal direction. While the stabilization member 600 can preferably engage the water pump 100 at the floatable member 200, it is contemplated for the stabilization member 600 to engage the water pump 100 at any location. For example, the stabilization member 600 can engage the connection member 400, the valve 320, the conduit 310, or the like.

In another embodiment, as shown in FIG. 5, a plurality of water pumps 100 are tethered to form a water pump conglomerate 700 to ensure the water displacement capabilities of each water pump 100 are focused on a specific location. The water pumps 100 can be combined by utilizing a conglomerate connector 710. The conglomerate connector 710 is preferably a steel cable. However, all suitable conglomerate connectors 710 are contemplated. The conglomerate connectors 710 can have any width suitable to tether a plurality of water pumps 100 together. While the conglomerate connector 710 can preferably engage the water pumps 100 at the floatable member 200, it is contemplated for the conglomerate connector 710 to engage the water pump 100 at any location. For example, the conglomerate connector 710 can engage the connection member 400, the valve 320, the conduit 310, or the like. The formation of the plurality of water pumps 100 can be any pattern or shape to achieve the desired result, for example, without limitation, a grid pattern, a line, a square, or the like.

The water pump conglomerate 700 can have a plurality of stabilization members 600. The number and position of the stabilization members 600 can depend on the number of water pumps 100 incorporated into the water pump conglomerate 700 and the shape of the water pump conglomerate 700. The number and location of engagement between the stabilization members 600 and the water pump conglomerate 700 can be determined to minimize the number of stabilization members 600 required. Preferably, the water pump conglomerate 700 has sixteen water pumps 100 positioned in four substantially parallel rows where each row has four water pumps 100 thereby forming a square shape as shown in FIG. 5. In this embodiment, water pump conglomerate 700 has four stabilization members 600 with one stabilization member 600 engaged with each water pump 100 positioned in the corner of the water pump conglomerate 700.

The method of pumping water from a first depth to a shallower depth is described as follows. A water pump 100 capable of utilizing energy from a passing wave to displace water from a first depth to a second depth at which a property of water at the first depth differs substantially from that property of water at the second depth is placed into a body of water. A passing wave lifts the floatable member 200 to a greater height than previously positioned and exerts an upward force upon the connection member 400. This upward force by way of the connection member 400 is transferred to the submergible member 300, specifically the valve 320 and the vertical supports 380. The submergible member 300 is then pulled by the floatable member 200 to a shallower depth. The water in the conduit 310 positioned above the valve 320 pushes the valve 320 closed allowing the conduit 310 to pull the water in the conduit 310 from a first depth to a shallower depth. Once the wave has passed, the floatable member 200 descends, thereby allowing the submergible member 300 to descend. The downward motion of the submergible member 300 causes water below the conduit 310 to push open the valve 320, thereby allowing water to flow in an upward direction through the conduit 310. This process begins again upon the passing of a subsequent wave.

The benefits of the water pump 100 and methods of use thereof are not restricted to pumping water from a first depth to a shallower depth, but can also be beneficial in pumping water from a first depth to a deeper depth. Those skilled in the art will recognize that the water pump 100 can be utilized to pump water from a first depth to a deeper depth by inverting the valve 320 to change the directional water flow of the valve 320. In such an embodiment, the valve 320 operates in the following manner. As the conduit 310 ascends, the water positioned above the valve member 340 exerts a force on the valve member 340. This force pushes the valve member 340 open thereby causing the valve member 340 to rotate around the hinge 350. The valve member 340 continues to rotate around the hinge 350 until ending in a substantially vertical position, thereby allowing water to flow past the valve member 340. As the conduit 310 begins to descend, the force from the water contained in the conduit 310 positioned below the valve member 340 pushes the valve member 340 down, thereby causing the valve member 340 to rotate around the hinge 350 until it rests against the valve stop 360. The valve member 340 is now in a substantially horizontal position thereby preventing water from flowing back through the valve 320 and pushing the water through the conduit 310. In such an embodiment, the water pump 100 can have a weight engaged to the submergible member 300 to aid the submergible member 300 in descending thereby pushing the water through the conduit 310 in a downward direction. The appropriate amount of weight will be chosen depending on the diameter of the conduit 310, the size of the water pump 100, or the weight of the water pump 100.

While the water pump 100 is preferably used to displace water from a first depth to a second depth to thermally modify weather, all applications are contemplated. For example, the water pump 100 can be used to aid in ocean uptake of atmospheric carbon dioxide. Oceans are natural carbon dioxide sinks and represent the largest active carbon sink on Earth. Carbon dioxide dissolves in the surface layer of the ocean causing the surface layer to become saturated and decreasing its ability to absorb more carbon dioxide. Use of the water pump 100 to mix subsurface water unsaturated with carbon dioxide with surface water saturated with carbon dioxide increases the ability of the surface layer to dissolve carbon dioxide. Similarly, the water pump 100 can be used to increase the uptake of other atmospheric gases, for example, without limitation, methane, nitrogen oxides, sulfur, dioxide, or the like.

In addition, the carbon sequestration efficiency of the ocean can be increased by increasing the surface layer phytoplankton concentration. Insufficient surface layer nutrients limit the surface layer phytoplankton concentration. While these nutrients are limited in the surface layer, they are abundant in the subsurface layer. The water pump 100 can be used to pump these nutrients to the surface layer thereby mixing nutrient filled subsurface water with surface water. This in turn would increase the phytoplankton concentrations, thereby increasing the carbon sequestration efficiency of the surface layers. In addition, an increase in surface layer nutrients can increase the population of water based fauna or flora.

In some circumstances, the death of substantial amounts of water based fauna or flora can occur due to low oxygen concentration at the water layer where the fauna or flora are found. Using the water pump 100 to increase the phytoplankton concentration can also increase oxygen levels of the appropriate layer, thereby preventing the death or damage of substantial amounts of water based fauna or flora.

In some circumstances, the death of substantial amounts of water based fauna or flora, for example, without limitation, coral, can occur due to higher water temperatures on the surface layer. Using the water pump 100 to reduce the water temperature of the surface layers can thereby prevent the death or damage of substantial amounts of water based fauna or flora.

In one embodiment, the water pump 100 can be used to generate electric power driven by the kinetic energy of a flowing medium, such as liquid. As shown in FIG. 6, the water pump 100 can have an energy receiving member 500 capable of extracting energy from a medium flow and converted into useful work. The energy receiving member 500 can be any device used to capture, collect, receive, or the like, energy, for example, a piston, a turbine, a propeller, or the like. The energy receiving member 500 can have a receiving housing 510, a capturing member 520, a support arm 530, and at least one support member 540 where the support member 540 is capable of engaging the generator 800 to the receiving housing 510. In one embodiment, the capturing member 520 is a plate or flat surface capable of capturing medium flow engaged to the support arm 540. The support arm 540 engages the generator 800 in a manner whereby the generator 800 converts mechanical energy to electrical energy. In one embodiment, the support arm 540 reciprocally engages the generator 800. The receiving housing 510 can be shaped, be positioned, and function in the same manner as described herein with regard to the valve housing 330. In one embodiment, the energy receiving member 500 engages the conduit 310 and/or vertical supports 380. In one embodiment, one end of the energy receiving member 500 engages the conduit 310 and/or vertical supports 380, and the other end of the energy receiving member 500 engages the floor of the body of water. The water pump 100 can have at least one energy receiving member 500 and/or at least on valve 320 where the water pump 100 is capable of creating electrical power and pumping water.

In one embodiment, the water pump 100 can have a generator 800 for converting mechanical energy to electrical energy. The generator 800 is coupled to the energy receiving member 500. The generator 800 can be any mechanism for converting mechanical energy, for example, energy derived rotationally from a turbine or propeller, energy derived from a reciprocating mechanism, or the like, to electrical energy.

The method of generating electrical power is described as follows. A water pump 100 capable of utilizing energy from a passing wave to generate electrical power is placed into a body of water. A passing wave lifts the floatable member 200 to a greater height than previously positioned and exerts an upward force upon the connection member 400. This upward force by way of the connection member 400 is transferred to the submergible member 300, specifically an energy receiving member 500, a valve 320, and/or vertical supports 380. The submergible member 300 is then pulled by the floatable member 200 to a shallower depth. The water in the conduit 310 positioned above the valve 320 pushes the valve 320 closed allowing the conduit 310 to pull the water in the conduit 310 from a first depth to a shallower depth. Once the wave has passed, the floatable member 200 descends, thereby allowing the submergible member 300 to descend. The downward motion of the submergible member 300 causes water below the conduit 310 to push open the valve 320, thereby allowing water to flow in an upward direction through the conduit 310. The upward flowing water applies a force to the capturing member 520 thereby pushing the capturing member 520 in an upward direction and generating mechanical energy. The mechanical energy is then converted to electrical power by way of the generator 800 coupled to the energy receiving member 500.

The application of the water pump 100 and methods of use thereof are not limited to oceanic bodies of water, but can also include seas, lakes, reservoirs, rivers, or the like.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention. Modifications and variations of the present invention are possible in light of the above teachings. It is therefore to be understood that the invention may be practiced otherwise than as specifically described herein.

What is claimed is:

1. A system for pumping water comprising:
a floatable member,
a submergible member capable of allowing water to flow in one direction having a conduit and a valve coupled to the conduit, and
a vertical support configured to receive a vertical force.

2. The system of claim 1 wherein said conduit extends downward from the floatable member, the conduit having a length extending to a first depth at which a property of water at the first depth substantially differs from the property of water at a second depth.

3. The system of claim 2 wherein the property of water comprises water temperature, dissolved-gas concentration, water chemical composition, or water biological composition.

4. The system of claim 1 wherein the system is used for biological management.

5. The system of claim 1 wherein the system is used for weather management.

6. The system of claim 1 wherein said valve comprises a valve member, a valve housing, a hinge, and a valve stop.

7. The system of claim 6 wherein said valve member is a flap valve.

8. The system of claim 1 further comprising a connection member capable of coupling the submergible member to the floatable member.

9. The system of claim 8 further comprising a connection device capable of coupling a connector support to the connection member.

10. The system of claim 1 wherein said vertical support structure engages a first valve and a second valve.

11. The system of claim 1 further comprising a stabilization member capable of decreasing horizontal movement.

12. The system of claim 1 wherein said submergible member comprises a passageway capable of allowing water to pass from the interior of the conduit to the exterior of the conduit.

13. The system of claim 1 further comprising a plurality of conduits.

14. The system of claim 1 further comprising a plurality of valves.

15. The system of claim 1 further comprising a depth adjusting member capable of adjusting the depth of the submergible member.
